(19) United States
(12) Patent Application Publication
(10) Pub. No.: US 2007/0064700 A1
(43) Pub. Date: Mar. 22, 2007

(54) Method and system for achieving spatial reuse over a resilient packet ring

(75) Inventor: Marc Holness, Ottawa (CA)

Correspondence Address: RIDOUT & MAYBEE;SUITE 2400, ONE QUEEN STREET EAST, TORONTO, ON, M5C3B1, CA

(73) Assignee: Nortel Networks Limited

(21) Appl. No.: 11/229,538

(22) Filed: Sep. 20, 2005

(51) Int. Cl. H04L 12/28

(52) U.S. Cl. 370/392; 370/401

(57) ABSTRACT

A system, method and/or station that provides for spatial reuse over a resilient packet ring (RPR) network. A sublayer in a station on an RPR network tracks associations between MAC addresses of bridges on the RPR network and remote addresses in an association database. Frames addressed to a remote destination may be sent directly to the associated MAC address. A sending station uses an extended frame format for sending frames to remote addresses. If the association database in the sending station specifies an associated bridge MAC address local to the RPR network then the extended frame is addressed to the specified MAC address and flooding is disabled. If there is no association in the database, then the sending station uses a reserved group address and floods the RPR network. The sublayer “learns” associations based upon frames received from stations that also have a spatially aware sublayer.

### FIELD OF THE INVENTION

The present invention relates to spatial reuse over resilient packet ring (RPR) networks and, in particular, to methods and systems for achieving spatial reuse in relation to bridged traffic on the RPR network.

### BACKGROUND OF THE INVENTION

The operation and interoperation of local area networks and metropolitan area networks are governed by a number of standards developed through IEEE 802 Working Groups. For example, the 802.3 Working Group develops standards related to Ethernet networks. The 802.15 Working Group develops standards for wireless local area networks (WIAN). The 802.17 Working Group develops standards related to RPR networks. The standards applicable to bridging between networks and relating to higher layer operations like media access control (MAC) layer activities are developed by the 802.1 Working Group.

One of the advantages realized by RPR networks is that they achieve spatial reuse to conserve bandwidth and resources. This is achieved because stations on the RPR network maintain a topology database that identifies the other stations and their relative position on the ring. This may be referred to as spatial awareness. When sending a frame to a particular station, the sending station can choose the shortest path based upon the ring topology. This is a more efficient use of resources as compared to circulating the frame around the entire ring.

Unfortunately, when frames are addressed from or to addresses not on the ring, spatial awareness is lost. Typically, when sending a frame to a remote address, a sending station floods the ring with the frame using an undirected transmission. One of the stations that receives the undirected transmission is the correct bridge and it may then forward the frame to the remote address. It will be appreciated that when handling bridged traffic an inefficient use of resources on the RPR network may result.

It would be advantageous to provide for a method, system, and/or station that improve such communications.

### SUMMARY OF THE INVENTION

The present invention provides a system, method and/or station that provides for spatial reuse over an RPR network. In particular, a sublayer is provided in a station on an RPR network. The sublayer tracks associations between MAC addresses for bridges on the RPR network and remote addresses in an association database. Frames that are addressed to the remote destinations may be sent directly to the associated MAC address.

A sending station uses an extended frame format for sending frames to remote addresses. If the association database in the sending station specifies an associated bridge MAC address local to the RPR network then the extended frame is addressed to the specified MAC address and flooding is disabled. If there is no association in the database, then the sending station uses a reserved group address and floods the RPR network.

To ensure backwards compatibility with legacy stations the sublayer “learns” associations based upon frames received from bridges that also have a spatially aware sublayer. In this regard, the sublayer updates the association database if one of two conditions is satisfied. The first condition is that the received frame is addressed to the reserved group address. The second condition is that the extended frame format is used and flooding is disabled. If either of these conditions is met, then the sublayer makes an association between the remote source address from off the RPR network and the bridge RPR MAC address that bridged the frame onto the RPR network.

In one aspect, the present invention provides a method of building a spatially aware sublayer in a station on a resilient packet ring (RPR) network. The RPR network includes a bridge having an RPR media access control (MAC) layer. The bridge receives a frame from a remote source and the bridge RPR MAC modifies the frame to produce an extended frame containing the bridge RPR MAC address in a local source field and transmits the extended frame over the RPR network. The method includes the steps of receiving the extended frame from the bridge, the extended frame including a local destination field and updating the sublayer to include an association between the bridge RPR MAC address and the remote source if either one of two conditions is true. The first condition is that the local destination field contains a predefined group address. The second condition is that an extended frame indicator is enabled and a flooding indicator indicates not flooded.

In another aspect, the present invention provides a method of achieving spatial reuse over a resilient packet ring (RPR) network using spatially aware sublayers (SAS). The RPR network includes a station, and the station includes a first RPR MAC layer having a first SAS. The method includes steps of receiving, at the RPR MAC layer from a higher layer, a frame including a destination field specifying a remote destination, and determining that the remote destination is not local to the RPR network. It further includes steps of establishing an extended frame for transmission on the RPR network by setting an extended frame indicator, where the extended frame includes a local destination field, and determining whether the first SAS contains an association between the remote destination and a bridge on the RPR network. If so, then the local destination field is set to the bridge and a flooding indicator is set to indicate not flooded. If not, then the local destination field is set to a predefined group address.

In yet another aspect, the present invention provides station on a resilient packet ring (RPR) network. The station includes an RPR MAC layer for receiving a frame from a higher layer and transmitting frames on the RPR network, where the received frame includes a destination field specifying a remote destination. It also includes a topology database for determining that the remote destination is not local to the RPR network and an association database containing associations between bridges in the RPR network and remote addresses. The station also includes a sublayer for establishing an extended frame for transmission on the RPR network by setting an extended frame indicator, where the extended frame includes a local destination field, and for determining whether the association database contains an association with respect to the remote destination. If so, the local destination field is set to a bridge specified by the association and a flooding indicator is set to indicate not flooded. If not, then the local destination field is set to a predefined group address.

In yet a further aspect, the present invention provides a station on a resilient packet ring (RPR) network. The RPR network includes a bridge interconnecting the RPR network with another network, and the bridge receives a frame from a remote source. The bridge includes a first RPR MAC layer having a first spatially aware sublayer for modifying the frame to produce an extended frame containing a bridge address in a local source field and for transmitting the extended frame on the RPR network. The station includes an input port connected to the RPR network for receiving the extended frame from the bridge, where the extended frame includes a local destination field, and an association database containing associations between bridges on the RPR network and remote addresses. The station also includes a second spatially aware sublayer for updating the association database to include an association between the bridge address and the remote source if either, the local destination field contains a predefined group address, or an extended frame indicator is enabled and a flooding indicator indicates not flooded.

In yet another aspect, the present invention provides a system for achieving spatial reuse over an RPR network. The system includes the RPR network, at least one bridge interconnecting the RPR network and a second network, and a first station on the RPR network. The first station includes a first RPR MAC layer for receiving a frame from a higher layer and transmitting frames on the RPR network, where the received frame includes a destination field specifying a remote destination, a topology database for determining that the remote destination is not local to the RPR network, and a first association database containing associations between bridges in the RPR network and remote addresses. The first station also includes a first spatially aware sublayer for establishing an extended frame for transmission on the RPR network by setting an extended frame indicator, wherein the extended frame includes a local destination field, and for determining whether the association database contains an association with respect to the remote destination. If so, the local destination field is set to a bridge specified by the association and a flooding indicator is set to indicate not flooded, and, if not, the local destination field is set to a predefined group address.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show one or more embodiments of the present invention, and in which:

FIG. 1 shows a block diagram of a communication network;

FIG. 2 shows a basic data frame structure used in connection with an RPR network;

FIG. 3 shows an extended data frame structure used in connection with the RPR network;

FIG. 4 diagrammatically shows IEEE 802.1 bridging architecture;

FIG. 5 shows the conceptual position of a spatially aware sublayer within an RPR MAC layer model;

FIG. 6 shows a block diagram of the communication network from FIG. 1 with a spatially aware sublayer implementation;

FIG. 7 shows in flowchart form, a method of operating a spatially aware sublayer for transmitting frames over an RPR network;

FIG. 8 shows, in flowchart form, a method of building a spatially aware sublayer from frames received over an RPR network;

FIG. 9 illustrates operation of an embodiment of the spatially aware sublayers during a first transmission over the communication network; and

FIG. 10 illustrates operation of an embodiment of the spatially aware sublayers during a second transmission over the communication network.

Similar reference numerals are used in different figures to denote similar components.

### DESCRIPTION OF SPECIFIC EMBODIMENTS

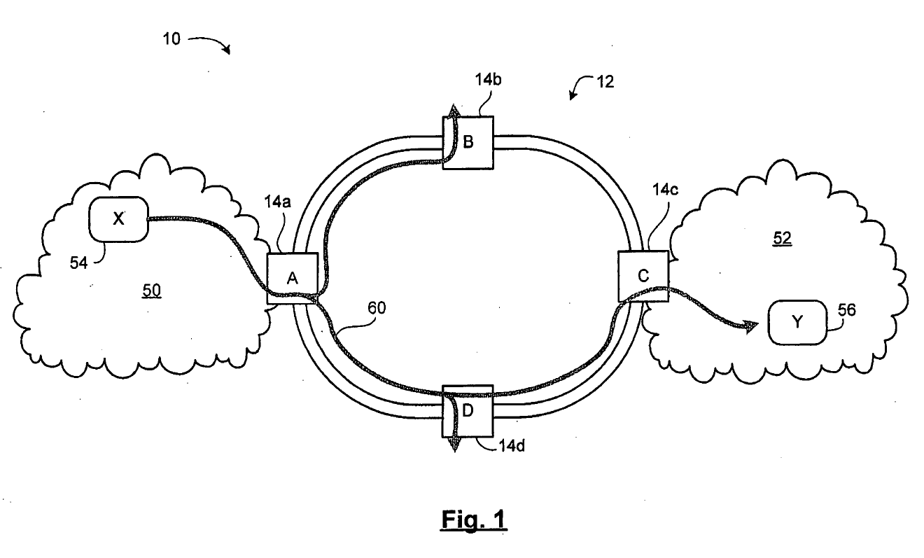

Reference is first made to FIG. 1, which shows a communication network 10. The communication network 10 includes a resilient packet ring (RPR) network 12. The RPR network 12 includes a number of stations 14 (shown individually as station A 14a, station B 14b, station C 14c, and station D 14d). Each station 14 may include a bridge, router, or host. In the example embodiment of FIG. 1, station A 14a and station C 14c are bridges interconnecting the RPR network 12 with other networks and, accordingly, hereinafter they may also be referred to as bridge A 14a and bridge C 14c, respectively.

The RPR network 12 conforms to the IEEE 802.17 standard, as described in IEEE Std 802.17-2004, the contents of which are hereby incorporated by reference. Bridge A 14a and bridge C 14c conform to IEEE 802.1D/Q standards, as described in IEEE Std 802.1D-2004, and IEEE Std 802.1Q, 2003 Edition, the contents of which are hereby incorporated by reference. As will be appreciated by those of ordinary skill in the art, the RPR network 12 has a dual ring topology having two ringlets for enabling bi-directional traffic.

It will also be appreciated that the RPR network 12 achieves “spatial reuse” for local ring traffic. Spatial reuse is achieved partly through destination stripping, meaning that a destination station on the ring strips a frame off the ring once it is received, rather than allowing the frame to continue circling the ring back to the source station.

The stations 14 on the RPR network 12 may (within an RPR MAC layer) each maintain a topology database that tracks the identity of other stations 14 on the ring and tracks the relative position of the stations 14 on the ring. Using the topology database, a station 14 may determine the shortest path between itself and a destination station 14 on the RPR network 12.

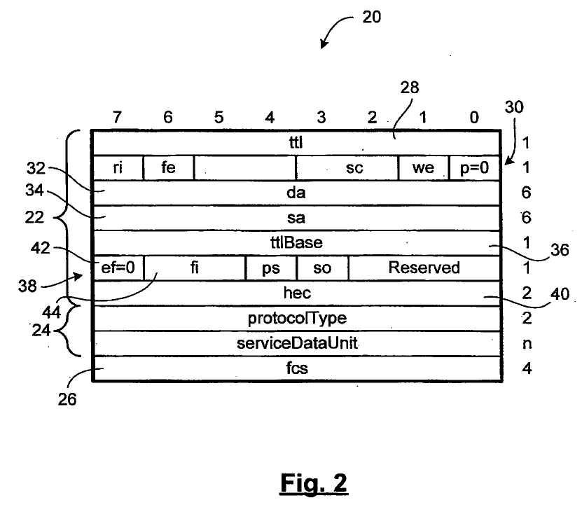

Reference is now made to FIG. 2, which shows a basic data frame structure 20 used in connection with the RPR network 12. The basic data frame structure 20 includes an RPR header portion 22, a payload portion 24, and a trailer portion 26. The trailer portion 26 may include a frame check sequence for error control and/or correction.

The RPR header portion 22 includes a ttl field 28, a baseControl field 30, a destination address field (da) 32, a source address field (sa) 34, a ttlBase field 36, an extendedControl field 38, and a header checksum field 40. The ttl field 28 and ttlBase field 36 relate to a mechanism for tracking and/or limiting the number of hops that a frame travels. The baseControl field 30 and extendedControl field 38 each contain a number of flags or other indicators. For example, the extendedControl field 38 includes an extended frame flag (ef) 42, a flooding indicator (fi) 44, and other indicators. The destination address field 32 specifies the 48 bit MAC address of the destination station on the RPR network. The source address field 34 specifies the 48 bit MAC address of the source station on the RPR network.

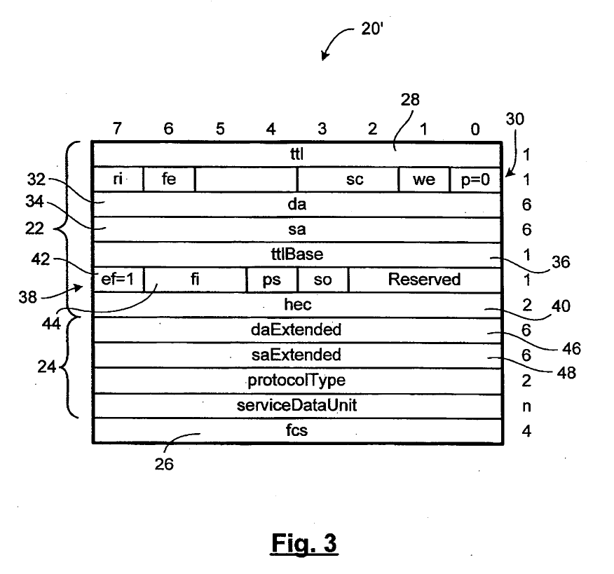

FIG. 3 shows an extended frame structure 20′ used in connection with the RPR network 12. The extended frame structure 20′ includes many of the same fields as the basic frame structure 20 shown in FIG. 2. The extended frame structure 20′ also includes, at the beginning of the payload portion 24, an extended destination address field (daExtended) 46 and an extended source address field (saExtended) 48. The extended frame structure 20′ is enabled when the extended frame flag (ef) 42 is set to logic 1.

Reference is again made to FIG. 1. The communication network 10 includes a second network 50 and a third network 52. In one embodiment, the second and third networks 50, 52 conform to an IEEE 802 standard; however they are not necessarily 802.17 compliant (i.e. RPR) networks. In one embodiment, the second and third networks 50, 52 may include 802.3 (Ethernet), 802.5 (Token Ring), and/or 802.11 (Wireless LAN) networks.

The second network 50 is connected to the RPR network 12 through bridge A 14a. The third network 52 is connected to the RPR network 12 through bridge C 14c.

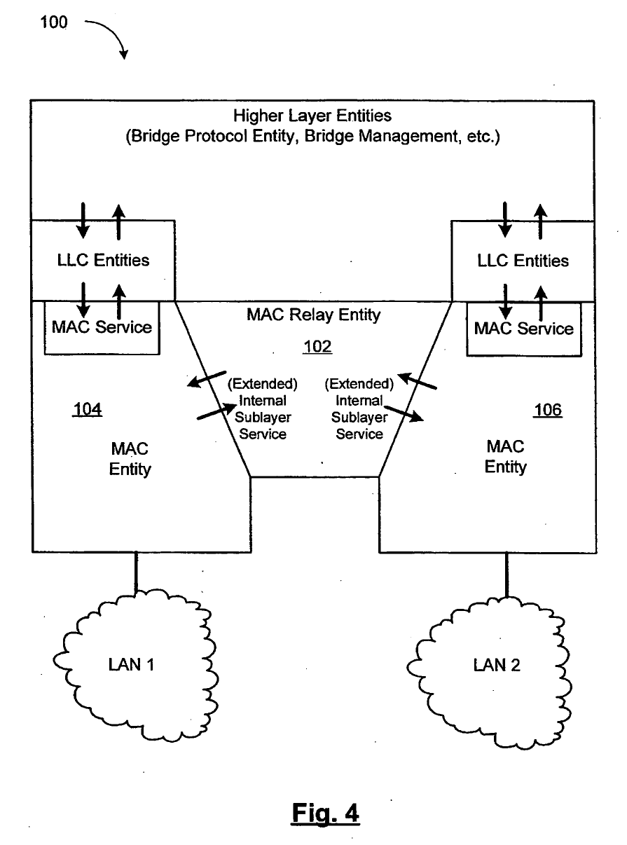

Reference is now made to FIG. 4, which diagrammatically shows IEEE 802.1 bridging architecture 100. With RPR networks, the RPR ring is the medium and the RPR MAC data path is considered part of the medium. The RPR MAC client (for example, a bridge) may be considered a service layer above the RPR MAC. As will be seen from FIG. 4, an IEEE 802.1 bridge may be conceptualized as a relay portion 102 with a port and MAC interface 104, 106 to each of the LANS. The (possibly) different MAC protocols communicate with the relay 102 through an interface referred to as internal sublayer services (ISS). When a frame is received through one of the ports it is passed by the MAC entity 104, 106 to the relay 102 (subject to some conditions). The relay 102 determines whether to forward the frame on one or more other ports.

In an 802.17 compliant network, when a frame contains a destination address that is not local to the ring, the ingress RPR MAC floods the RPR network with the frame. In other words, it is not unicast to a specific station. Instead it is received by all stations on the ring. It will be appreciated, that this results in unnecessary consumption of bandwidth.

For example, with reference to FIG. 1, the second network 50 may include MAC client X 54, which sends a frame addressed to MAC client Y 56 within the third network 52. Ideally, the frame would travel a path from MAC client X 54 to bridge A 14a, around a part of the RPR network 12 to bridge C 14c, and from bridge C 14c to MAC client Y 56. However, the RPR MAC layer in bridge A 14a does not recognize the address of MAC client Y 56 therefore floods the RPR network 12 with the frame, as shown by path 60. Bridge C 14c receives the frame and its relay portion 102 may recognize the address as belonging to the third network 52.

It will be appreciated that the same spatial reuse problem may arise when the frame originates locally; it need not come from a remote source. For example, a host station 14 on the RPR network 12 may address a frame to a remote destination. A higher layer, i.e. a MAC client layer, within the host station 14 passes the frame to the RPR MAC layer, whereupon the RPR MAC layer elects to flood the RPR network 12 with the frame because it does not recognize the remote destination as being local to the RPR network 12.

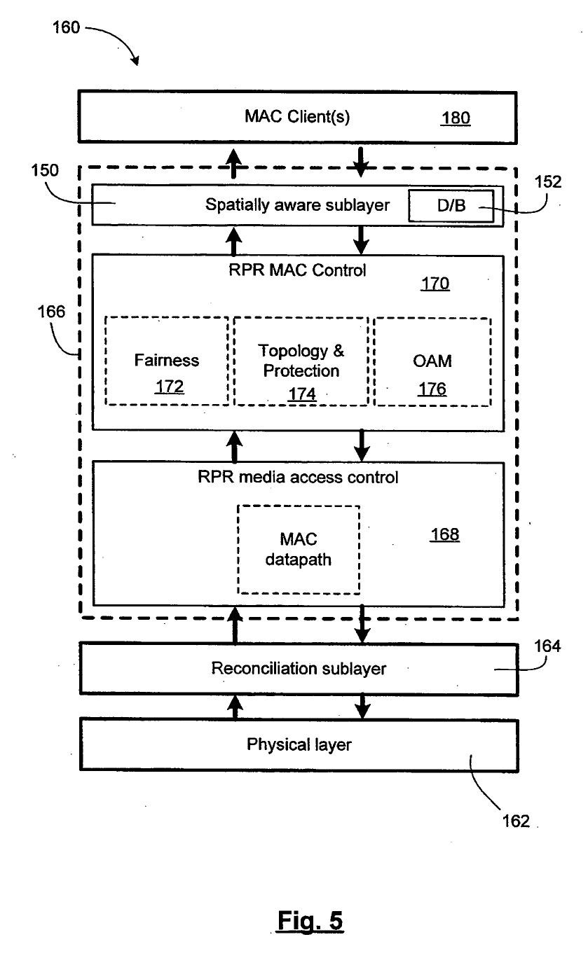

Accordingly, in accordance with one aspect of the present invention, a station includes a spatially aware sublayer (SAS). The SAS is an RPR MAC sublayer that supports spatial reuse over bridged networks. Reference is now made to FIG. 5, which shows the conceptual position of an SAS 150 within a MAC layer model 160. The model 160 illustrates that a reconciliation sublayer 164 lays between the physical media 162 and MAC layers 166. The MAC layers 166 include the MAC datapath layer 168, the MAC control layer 170, and the SAS 150. The MAC control layer 170 implements fairness 172, topology and protection 174, and OAM 176 functions. The MAC client layer 180 sits atop the MAC layers 166.

The SAS 150 provides an association database 152 that contains associations between bridges and remote addresses. In other words, the association database 152 identifies the RPR MAC address for the correct egress bridge through which to direct a frame in order for it to reach a specific remote address.

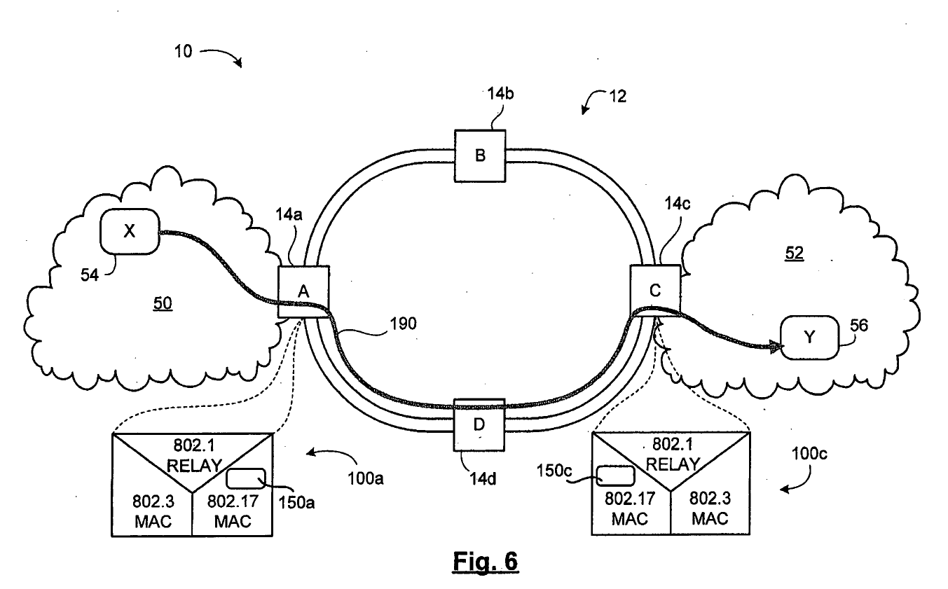

Reference is now made to FIG. 6, which shows the communication network 10 from FIG. 1 with a SAS 150 implementation. In particular, it will be noted that bridge A 14a includes SAS 150a and bridge C 14c includes SAS 150c. It will be appreciated that an SAS 150 may be implemented in stations 14 other than bridges, but for the purposes of this example embodiment SAS 150a and SAS 150b are implemented within bridges.

When MAC client X 54 sends a frame addressed to MAC client Y 56 within the third network 52, the frame is first received by bridge A 14a. Bridge A 14a determines, based upon its SAS 150a association database that the destination address, i.e. MAC client Y 56, is reachable through bridge C 14c and, in particular, through the RPR MAC address for bridge C 14c. Accordingly, rather than flooding the frame on the RPR network 12, bridge A 14a unicasts the frame to bridge C 14c, as shown by path 190. The RPR network 12 thereby achieves spatial reuse despite the fact that the frame is bridging networks.

The RPR network 12 employs the extended frame format 20′ (FIG. 3). The extended frame format 20′ allows the frame to retain the MAC client source address information (e.g. MAC client X) and the MAC client destination address information (e.g. MAC client Y) within the saExtended 48 and daExtended 46 fields, respectively. The da field 32 and sa field 34 contain the local destination and source addresses (e.g. RPR MAC addresses for bridge C and bridge A), respectively.

The SAS 150 is configured to operate in accordance with transmission and reception rules. These rules determine when and how the SAS 150 participates in the transmission and reception of frames. For example, when a frame is received by the RPR MAC layer from the relay for transmission on the RPR network 12, the transmission rules govern if and how the SAS 150 modifies the frame format and header information. When a frame is received by the RPR MAC layer through the RPR network 12, the reception rules determine if and how the association database 152 is updated based upon the frame received.

It will be appreciated that in many embodiments not all stations are SAS-enabled or “enchanced” stations. Some stations may be “legacy” or “basic” stations that do not contain an SAS implementation. Accordingly, through the transmission and reception rules, the SAS 150 is configured to account for the possibility of legacy stations on the RPR network 12.

It will also be appreciated that RPR network 12 and its stations 14 must conform to the prevailing standards, including IEEE 802.17 and IEEE 802.1D/Q. Accordingly, through the transmission and reception rules, the SAS 150 is configured to conform to these standards.

The SAS 150 operates to transmit frames in accordance with the following transmission rules:

IF (sa & da) are local (i.e. found in topology
database),

then, pass to RPR MAC for local unicast

transmission
ELSE,

set ef = 1 (use extended frame)
saExtended = source MAC client address
daExtended = destination MAC client address
IF destination MAC address [& vid] found in

association database, then RPR header da =
associated RPR MAC address and fi = fi_none

ELSE, RPR header da = RPRGroupAddress
pass to RPR MAC for transmission

where, RPRGroupAddress is a designated predefined address chosen from one of the available IEEE 802.1D reserved group addresses. This predefined address is used to indicate that the transmitting RPR station has not located an associated RPR MAC bridge in its association database that corresponds to the remote destination MAC address. The extended frame is then flooded onto the RPR network. This ensures that the extended frame reaches all the stations on the RPR network in this situation.

If the transmitting RPR station locates the associated RPR MAC address for a bridge that corresponds to the destination MAC address, then it unicasts the extended frame to the RPR MAC address for the associated bridge.

The association database is populated or “learns” the correct associations when frames are received over the RPR network from an SAS-enabled RPR bridge. In other words, the reception rules govern when the association database 152 is updated. The SAS 150 builds associations in accordance with the following reception rules:

IF da = RPRGroupAddress,

THEN SAS d/b is updated with {saExtended, [&

vid]} [symbol] sa
OR
IF (ef=1) AND (fi=fi_none),

THEN SAS d/b is updated with {saExtended, [&

vid]} [symbol] sa

From the above reception rules, it will be noted that there are two instances when the association database 152 is updated. First, if the da field in a received frame is set to RPRGroupAddress, then the SAS 150 knows that the frame was sent by an SAS-enabled RPR bridge. Therefore, it can associate the RPR MAC address of the SAS-enabled bridge (sa) with the address of the remote MAC client that originated the frame (saExtended).

Second, if the frame is an extended frame and flooding is turned off, then the SAS 150 knows that the frame was sent by an SAS-enabled RPR bridge, because a basic RPR bridge would have used an extended frame when bridging across networks and it would have been flooded on the RPR network. Therefore, based upon the combination of an extended frame and no flooding, the SAS 150 can associate the address of the SAS-enabled bridge (sa) with the address of the remote MAC client that originated the frame (saExtended).

Note that references above to [& vid] as a possible addition to the source and/or destination MAC client address are intended to allow for the possibility of virtual LAN identification numbers.

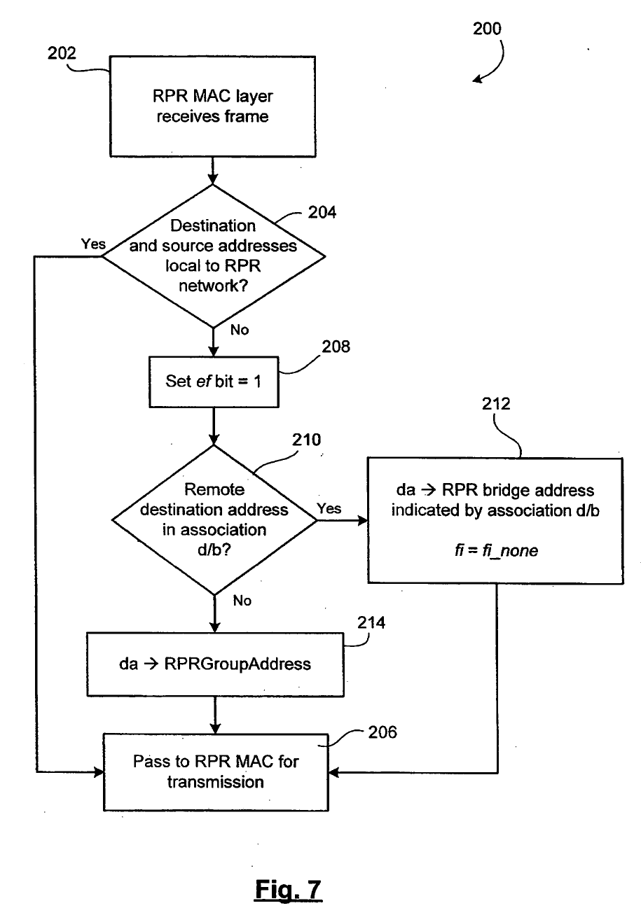

Reference is now made to FIG. 7, which shows, in flowchart form, a method 200 of operating a spatially aware sublayer (SAS) for transmitting frames over an RPR network. The method 200 begins in step 202 with the receipt of a frame by the RPR MAC layer. The frame may be passed to the RPR MAC layer from a higher layer in the station, such as, for example, a relay (in the case of a bridge) or a MAC client layer (in the case of a host). The frame is addressed to a destination address.

In step 204, the SAS determines if the source MAC address and the destination MAC address are local to the RPR network. If so, then in step 206 the SAS passes the frame to the RPR MAC for transmission on the RPR network.

If the source MAC address or destination MAC address are not local, then from step 204 the method 200 goes to step 208, wherein it sets the ef bit to 1, meaning that an extended frame format is used. Then in step 210, with a remote destination address, the SAS searches the association database to determine whether it contains an entry for the destination address (and, vid, if any). If the database contains an entry associating the remote destination address with an RPR MAC address, then the method 200 continues to step 212, where the destination address field da is set to the RPR MAC address indicated by the database. The flooding indicator is also set to fi_none in step 212 to prevent flooding.

It will be appreciated that if the destination address is local to the RPR network, then the extended frame is unicast to the destination address. In these circumstances, the SAS still uses the extended frame format because it involves a remote source and the extended frame format without flooding will allow other stations on the RPR network to build an association between the bridge sending the frame and the remote source.

If the association database does not contain an entry corresponding to the remote destination address, then from step 210 the method 200 moves to step 214, wherein the destination address field da is set to the predefined group address RPRGroupAddress.

Steps 212 and 214 both lead to step 206, wherein the extended frame is passed to the RPR MAC for transmission on the RPR network.

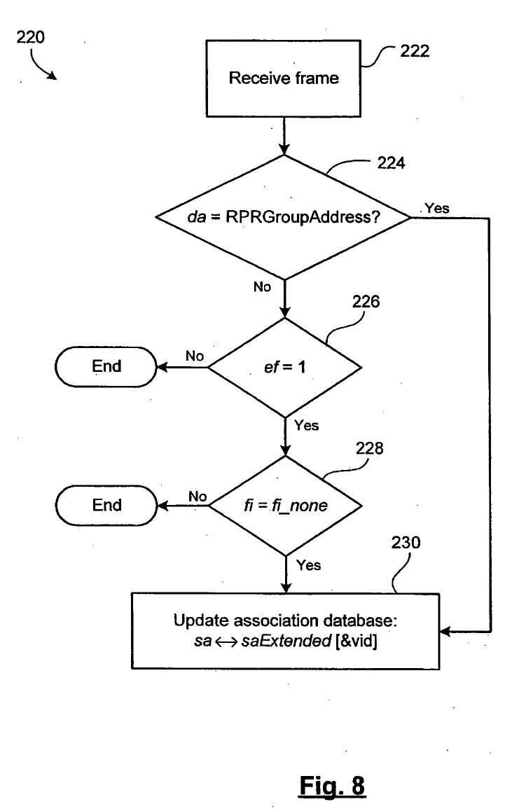

Reference is now made to FIG. 8, which shows a method 220 of building a spatially aware sublayer (SAS) from frames received over an RPR network.

The method 220 begins in step 222 with the receipt of a frame over the RPR network. The frame is addressed to a destination MAC address. The SAS attempts to determine if the frame has been received from an SAS-enabled RPR station and if the frame relates to a bridged transmission.

In this regard, the SAS looks for two possible indicators. First, the SAS determines, in step 224, whether the RPR header destination address da is set to the predefined RPRGroupAddress. If so, then it concludes the frame meets the criteria for being a bridged communication coming from an SAS-enabled bridge, and the method 200 continues to step 230. Otherwise, it continues in step 226.

In step 226, the SAS assesses whether the ef bit is set to indicate an extended frame. If so, then it assesses whether the flooding indicator is set to fi_none to indicate no flooding. If both these criteria are met, then the SAS concludes that the frame is a bridged transmission from an SAS-enabled bridge. Accordingly, the method 200 proceeds to step 230.

In step 230, the SAS updates its association database by building an association between the address of the SAS-enabled RPR bridge, found in sa, and the address of the remote source MAC client, found in saExtended.

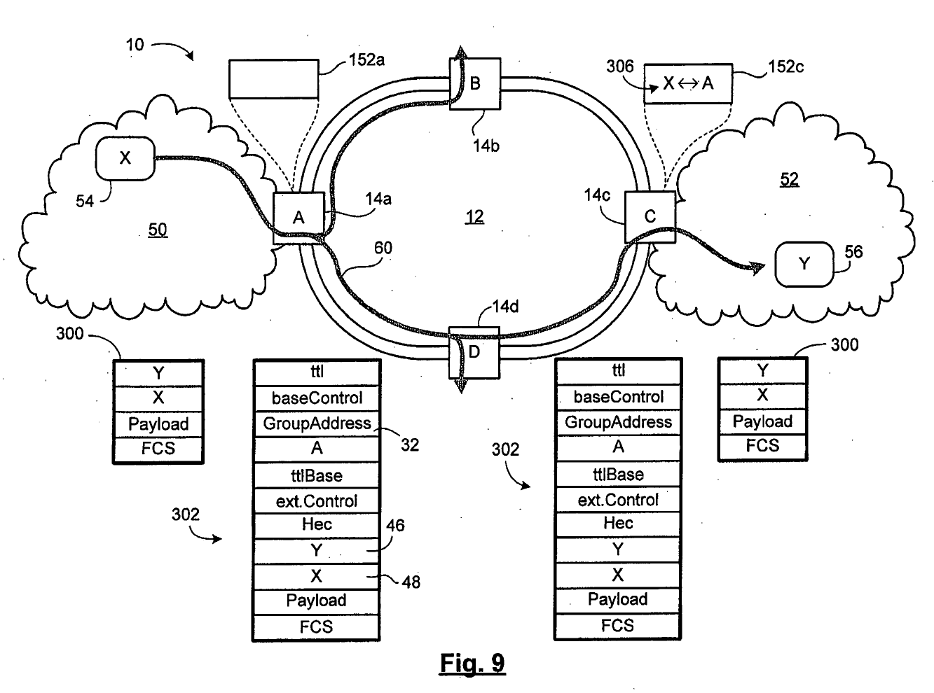

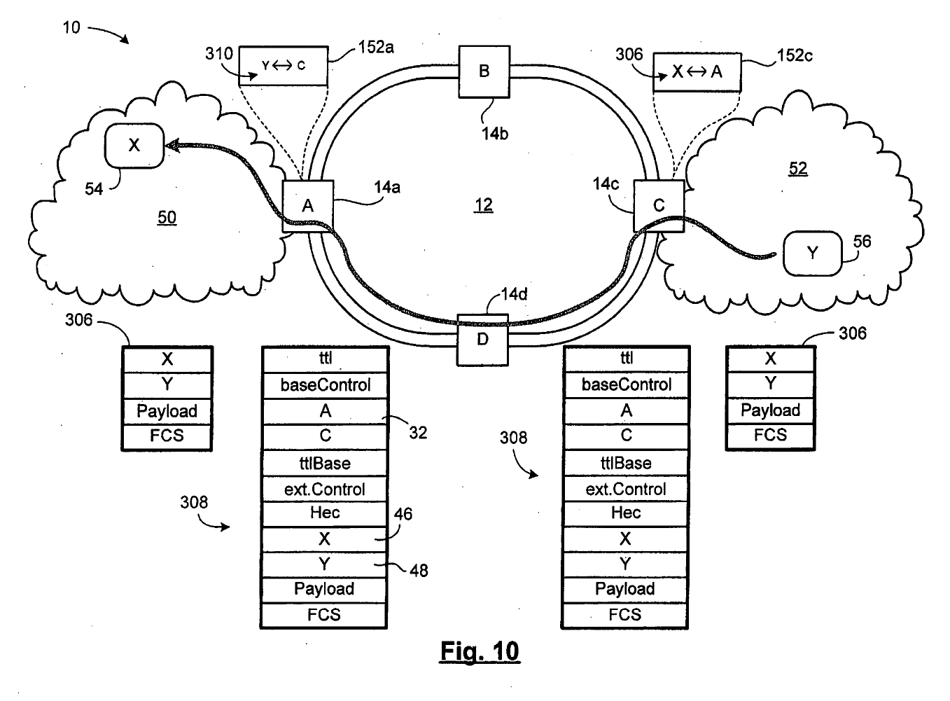

Reference is now made to FIGS. 9 and 10, which illustrate operation of the SAS over the communication network 10 of FIGS. 1 and 6. Bridge A 14a includes a first association database 152a as part of the first SAS. Bridge C 14c includes a second association database 152c as part of the second SAS.

FIG. 9 illustrates the process of a first transmission. FIG. 10 illustrates the process of a second transmission.

Referring first to FIG. 9, the MAC client X 54 initiates the first transmission by sending a first frame 300 with a payload addressed to MAC client Y 56 over the second network 50. The first frame 300 is received by bridge A 14a at the RPR network 12. The bridge A 14a, and more particularly, the first SAS, repackages the payload using a first extended frame 302 by setting the ef bit to 1. The first extended frame 302 includes the addresses for MAC client X 54 and MAC client Y 56 in the saExtended field and daExtended field, respectively.

The first SAS consults the first association database 152a to determine if it contains any associations corresponding to MAC client Y 56. Finding none, the first SAS sets the destination address da field 32 to the predefined GroupAddress. The RPR MAC level in bridge A 14a then floods the first extended frame 302 on the RPR network 12 to the various bridges 14.

The RPR MAC of bridge C 14c receives the first extended frame 302. Using the reception rules, the second SAS notes that the first extended frame 302 is addressed to the predefined GroupAddress. Accordingly, the second SAS updates the second association database 152b to add an association 304 between MAC client X 54 (saExtended) and the RPR MAC address for bridge A 14a (sa). It then passes the frame to the relay portion of bridge C 14c, where it may be determined that MAC client Y 56 is a member of the second network 56. Accordingly, bridge C 14c forwards the first frame 300 to MAC client Y 56.

Referring now to FIG. 10, MAC client Y 56 sends a second frame 306 over the third network 52. The second frame 306 is addressed to MAC client X 54.

Bridge C 14c receives the second frame 306 and passes it to the RPR MAC layer for transmission on the RPR network 12. At the RPR MAC layer, the second SAS repackages the payload using an extended frame format to create a second extended frame 308. The second association database 152c includes the association 304 that indicates that MAC client X 54 is accessible through the RPR MAC address for bridge A 14a. Accordingly, the second SAS addresses the second extended frame 308 to the RPR MAC address for bridge A 14a. It also sets the flooding indicator fi field to fi_none to prevent flooding. The second extended frame 308 is then sent to bridge A 14a over the RPR network 12. Because the second extended frame 308 is directly addressed to bridge A 14a and flooding is disabled, the frame traverses only a portion of the ring, thereby saving bandwidth through spatial awareness.

At bridge A 14a, the second extended frame 308 is received and, using the reception rules, the first SAS recognizes that the second extended frame 308 includes an ef bit set to 1 (indicating an extended frame format) and a flooding indicator fi set to fi_none (i.e. flooding is disabled). Based upon this finding, the first SAS concludes that it received the second extended frame 308 from an SAS-enabled bridge and, therefore, it updates the first association database 152a. In particular, it adds an association 310 between MAC client Y 56 (saExtended) and the RPR MAC address for bridge C 14c (sa). Bridge A 14a then forwards the second frame to MAC client X 54 over the second network 50.

It will be appreciated that further communications between MAC client X 54 and MAC client Y 56 will use direct unicast communications over the RPR network 12 by virtue of the associations 306, 310 established in the association databases 152a, 152c. Moreover, the associations may be used to direct communications from other MAC clients to MAC client X 54 or MAC client Y 56. For example, a MAC client may address a frame to MAC client Y 56. If the frame is sent through the second network 50 then bridge A 14a will recognize the association between bridge C 14c and MAC client Y 56 and will unicast the frame to bridge C 14c over the RPR network 12.

It will also be appreciated, that station D 14d may similarly build a third SAS based upon the communications on the RPR network. To the extent that the first and second communications between MAC client X 54 and MAC client Y 56 pass station D 14d, the third SAS within station D 14d may learn the associations between the bridges A and C, 14a, 14c, and the respective remote addresses for MAC client X 54 and MAC client Y.

Those skilled in the art will appreciate that the association databases 152 may also include timestamps corresponding to each association stored in the databases 152. The timestamps may mark the time at which the association was created and/or most recently updated. Associations that are older than a threshold duration may be removed from the database 152 to prevent accumulation of out-of-date associations in the database 152. This may also permit the SAS to react to alterations in topology. In another embodiment, the SAS may respond to a control frame or other such message to clear its database 152 of associations. Such a control frame may be sent by a network administrator as part of a reconfiguration of network resources/topology.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of building a spatially aware sublayer in a station on a resilient packet ring (RPR) network, the RPR network including a bridge having an RPR media access control (MAC) layer, the bridge receiving a frame from a remote source, the bridge RPR MAC modifying the frame to produce an extended frame containing the bridge RPR MAC address in a local source field and transmitting the extended frame over the RPR network, the method comprising the steps of:
receiving the extended frame from the bridge, the extended frame including a local destination field; and
updating the sublayer to include an association between the bridge RPR MAC address and the remote source if either one of two conditions is true,
wherein the first condition is that said local destination field contains a predefined group address, and
wherein the second condition is that an extended frame indicator is enabled and a flooding indicator indicates not flooded.

2. The method claimed in claim 1, wherein said extended frame includes a frame header and a payload, said frame header including said local destination field and said local source field, and said payload including an extended destination field and an extended source field, and said extended source field containing an address for said remote source.

3. The method claimed in claim 2, wherein said frame is addressed to a remote destination, and wherein said extended destination field contains an address for said remote destination, said remote destination being a MAC address on a network other than the RPR network.

4. The method claimed in claim 1, wherein, under the first condition, the extended frame is flooded onto the RPR network by the bridge RPR MAC, and wherein, under the second condition, the extended frame is unicast over the RPR network by the bridge RPR MAC to a local RPR MAC address, said local destination field containing said local RPR MAC address.

5. The method claimed in claim 1, wherein said extended frame indicator comprises an ef bit within a frame header, said flooding indicator comprises an fi field within said frame header, and wherein when said second condition is true, said ef bit is set to 1 and said fi field is set to fi_none.

6. A method of achieving spatial reuse over a resilient packet ring (RPR) network using spatially aware sublayers (SAS), the RPR network including a station, the station including a first RPR MAC layer having a first SAS, the method comprising steps of:
receiving, at the RPR MAC layer from a higher layer, a frame including a destination field specifying a remote destination;
determining that said remote destination is not local to the RPR network;
establishing an extended frame for transmission on the RPR network by setting an extended frame indicator, said extended frame including a local destination field;
determining whether said first SAS contains an association between said remote destination and an RPR MAC address for a bridge on the RPR network, and
if so, setting said local destination field to said RPR MAC address for said bridge and setting a flooding indicator to indicate not flooded; and
if not, setting said local destination field to a predefined group address.

7. The method claimed in claim 6, further including a step of transmitting said extended frame on the RPR network, wherein said transmission is unicast if said local destination field is set to said RPR MAC address for said bridge, and wherein said transmission is flooded if said local destination field is set to said predefined group address.

8. The method claimed in claim 6, wherein said extended frame includes a frame header and a payload, said frame header including said local destination field and a local source field, said local source field containing an address for said station, and said payload including an extended destination field and an extended source field, said extended destination field containing an address for said remote destination.

9. The method claimed in claim 6, wherein the frame is received by the station from a remote source having a remote source MAC address, and wherein said bridge includes a second RPR MAC layer having a second SAS, and wherein said bridge connects the RPR network to a second network, the second RPR MAC layer performing steps of:
receiving the extended frame from the station over the RPR network; and
updating the second SAS to include an association between the station and the remote source based upon determining that either,
(a) said local destination field contains said predefined group address, or
(b) said extended frame indicator is enabled and said flooding indicator is disabled.

10. The method claimed in claim 9, wherein said station has an RPR MAC address said association associates said RPR MAC address with said remote source MAC address.

11. The method claimed in claim 6, wherein said extended frame indicator comprises an ef bit within a frame header, said flooding indicator comprises an fi field within said frame header, and wherein said ef bit is set to 1 and said fi field is set to fi_none.

12. A station on a resilient packet ring (RPR) network, the station comprising:
an RPR MAC layer for receiving a frame from a higher layer and transmitting frames on the RPR network, the received frame including a destination field specifying a remote destination;
a topology database for determining that said remote destination is not local to the RPR network;
an association database containing associations between RPR MAC addresses of bridges in the RPR network and remote addresses; and
a sublayer for establishing an extended frame for transmission on the RPR network by setting an extended frame indicator, said extended frame including a local destination field, and for determining whether said association database contains an association with respect to said remote destination and,
if so, setting said local destination field to an RPR MAC address specified by said association and setting a flooding indicator to indicate not flooded, and,
if not, setting said local destination field to a predefined group address.

13. The station claimed in claim 12, wherein said extended frame is unicast to said RPR MAC address if said association database contains said association, and said extended frame is flooded on the RPR network if said association database does not contain said association.

14. The station claimed in claim 12, wherein said extended frame includes a frame header and a payload, said frame header including said local destination field and a local source field, said local source field containing an address for the station, and said payload including an extended destination field and an extended source field, said extended destination field containing an address for said remote destination.

15. The station claimed in claim 14, wherein the station receives said frame from a remote source, and wherein said extended source field contains an address for said remote source.

16. The station claimed in claim 12, wherein said extended frame indicator comprises an ef bit within a frame header, said flooding indicator comprises an fi field within said frame header, and wherein said ef bit is set to 1 and said fi field is set to fi_none.

17. The station claimed in claim 12, wherein the station comprises a bridge interconnecting the RPR network with another network, and wherein said bridge received said frame from a remote source through said another network.

18. A station on a resilient packet ring (RPR) network, the RPR network including a bridge interconnecting the RPR network with another network, the bridge receiving a frame from a remote source, the bridge including a first RPR MAC layer having a first spatially aware sublayer for modifying the frame to produce an extended frame containing a bridge address in a local source field and transmitting the extended frame on the RPR network, the station comprising:
an input port connected to the RPR network for receiving the extended frame from the bridge, the extended frame including a local destination field;
an association database containing associations between RPR MAC addresses for bridges on the RPR network and remote addresses; and
a second spatially aware sublayer for updating said association database to include an association between the bridge RPR MAC address and the remote source if either,
(a) said local destination field contains a predefined group address, or
(b) an extended frame indicator is enabled and a flooding indicator is disabled.

19. The station claimed in claim 18, wherein said extended frame includes a frame header and a payload, said frame header including said local destination field and said local source field, and said payload including an extended destination field and an extended source field, and said extended source field containing an address for said remote source.

20. The station claimed in claim 19, wherein the frame is addressed to a remote destination, and wherein said extended destination field contains an address for said remote destination.

21. The station claimed in claim 18, wherein said extended frame indicator comprises an ef bit within a frame header, said flooding indicator comprises an fi field within said frame header, and wherein when said second condition is true, said ef bit is set to 1 and said fi field is set to fi_none.

22. A system for achieving spatial reuse over an RPR network, the system comprising:
the RPR network;
at least one bridge interconnecting said RPR network and a second network; and
a first station on said RPR network, said first station including,
a first RPR MAC layer for receiving a frame from a higher layer and transmitting frames on the RPR network, the received frame including a destination field specifying a remote destination;
a topology database for determining that said remote destination is not local to the RPR network;
a first association database containing associations between RPR MAC addresses for bridges in the RPR network and remote addresses; and
a first spatially aware sublayer for establishing an extended frame for transmission on the RPR network by setting an extended frame indicator, said extended frame including a local destination field, and for determining whether said association database contains an association with respect to said remote destination and,
if so, setting said local destination field to an RPR MAC address specified by said association and setting a flooding indicator to indicate not flooded, and,
if not, setting said local destination field to a predefined group address.

23. The system claimed in claim 22, wherein said first station comprises a first bridge and wherein said frame is received by said first bridge from a remote source, and wherein said system further comprises:
a second station, including
an input port connected to the RPR network for receiving said extended frame from said first bridge; and
a second association database containing associations between RPR MAC addresses of bridges on the RPR network and remote addresses; and
a second sublayer for updating said second association database to include an association between said first bridge RPR MAC address and said remote source if either,
(a) said local destination field contains said predefined group address, or
(b) said extended frame indicator is enabled and said flooding indicator indicates not flooded.
